(19) United States
(12) Patent Application Publication
(10) Pub. No.: US 2003/0082966 A1
(43) Pub. Date: May 1, 2003

(54) Superabsorbent disposable material

(76) Inventors: Elisa Menday, Farmingdale, NY (US); Neville Menday, Farmingdale, NY (US)

Correspondence Address: Thomas A. O'Rourke, Wyatt, Gerber & O'Rourke, 99 Park Avenue, New York, NY, 10016, US

(21) Appl. No.: 09/999,268

(22) Filed: Oct. 31, 2001

(51) Int. Cl. B32B 1/02

(52) U.S. Cl. 442/1; 428/36.1

(57) ABSTRACT

The present invention relates to a disposable, absorbent article having a liquid impervious backsheet layer, a liquid permeable topsheet layer disposed in facing relation with the backsheet layer, an absorbent layer interposed between the backsheet layer and the topsheet layer, and a fabric layer interposed between the backsheet layer and the absorbent layer. Preferably, the article further contains a second fabric layer disposed in facing relation with the first fabric layer and a scrim support layer interposed between and laminated to each of the fabric layers. These articles are useful for containing liquids such as those commonly encountered in medical, nursing, health care, hospital, laboratory and industrial fields. Due to their high tensile strength these articles are particularly useful in moving medical patients.

### BACKGROUND OF THE INVENTION

1. Field of the Invention

The instant invention relates generally to disposable, highly absorbent sheets and pads having superior strength and more specifically it relates to disposable, absorbent, multilayer composite sheets and pads suitable for medical scientific, veterinarian, pet and other usage.

2. Description of the Prior Art

Disposable, absorbent pads and sheets are known in the art. For example, U.S. Pat. No. 3,956,782 (Morrison, R. D., May 18, 1976) discloses a contour mattress cover comprising a fluid impervious foundation layer laminated to an absorbent layer.

U.S. Pat. No. 3.989,867 (Sisson, B Nov. 2, 1976) discloses an absorbent device having an absorbent body and liquid impervious backsheet underlying the absorbent body.

U.S. Pat. No. 4,923,453 (Bullard, Jr M., May 8, 1990) discloses an absorbent utility cover comprising three layers, a bottom layer of waterproof plastic, a central absorbent layer and top semi-porous layer.

U.S. Pat. No. 5,081,729 (Menday, E. C., Jan. 21, 1992) discloses disposable fitted birthing sheet comprising liquid impervious backing layer, a middle layer of absorbent material and a liquid permeable top layer.

While these patents all disclose multi-layer absorbent articles, they do not teach multi-layer absorbent articles having high tensile strength which are suitable for heavy use, for example, lifting a patient.

### SUMMARY OF THE INVENTION

The present invention is concerned with a composition suitable for use in disposable, absorbent multilayer composite sheets and pads having a high tensile strength. More particularly, the present invention is directed to multilayer sheet structures that are highly absorbent. These sheet structures may include one or more laminates, co-extruded layers and combinations thereof.

A primary object of the present invention is to provide a disposable, absorbent article that will absorb a relatively large quantity of fluid in comparison to other absorbent structures.

Another object of the present invention is to provide a disposable, absorbent article having an improved tensile strength such that the structures of the present invention do not tear easily when used.

It is a further object of the invention to provide a disposable, absorbent article having improved puncture resistance.

A still further object of the present invention is to provide a disposable, absorbent article that will not tear readily when a patient or other object is being transported by lifting the sheet.

An additional object of the present invention is to provide a multi-layer disposable, absorbent article having a liquid-impervious layer, an absorbent layer, and a tensile strength-providing layer. Additional layers, such as a liquid-permeable top layer, may also be present.

A further object of the present invention is to provide a disposable, absorbent article that is easy to use, economical to manufacture and safe and convenient to dispose.

The foregoing and other objects, advantages and characterizing features will become apparent from the following description of certain illustrative embodiments of the invention.

The novel features which are considered characteristic for the invention are set forth in the appended claims. The invention itself, however both as to its construction and its method of operation, together with additional objects and advantages thereof, will be best understood from the following description of the specific embodiments when read and understood in connection with the accompanying drawings. Attention is called to the fact however, that the drawings are illustrative only, and that changes may be made in the specific construction illustrated and described within the scope of the appended claims.

### BRIEF DESCRIPTION OF THE DRAWING FIGURES

FIG. 1 is a cross-sectional view taken through an example of the article of the present invention

FIG. 2 is an exploded cross-sectional view taken through an article of the present invention, wherein the major layers are shown individually.

FIG. 3 is a further exploded cross-sectional view taken through an article of the present invention, wherein each layer is shown individually.

FIG. 4 is a descriptive exploded view of the article of FIG. 3, wherein the preferred characteristics of the various layers of the present invention, are illustrated.

FIG. 5 is a cross sectional view of an alternative embodiment of the present invention.

FIG. 6 is a cross sectional view of an additional alternative embodiment of the present invention.

### LIST OF REFERENCE NUMERALS UTILIZED IN THE DRAWINGS

10—absorbent, multi-layer article that is preferably disposable

12—cover layer that is preferably permeable

14—core layer that is preferably absorbent

16—optional high tensile strength-providing layer

18—liquid-impermeable barrier layer

20—fabric layer preferably a spunbond material

22—polyester/polypropylene scrim

24—high tensile strength fabric

26—preferred permeable cover stock, having a weight of between about 10 and about 40 g/m²

28—preferred absorbent core, having a weight of between about 100 and about 400 g/m²

30—waterproof barrier

32—polyester/polypropylene scrim

34—preferred polypropylene fabric, having a weight of between about 20 and about 80 g/m²

36—preferred polypropylene fabric, having a weight of between about 20 and about 80 g/m²

### DETAILED DESCRIPTION OF THE PREFERRED EMBODIMENTS

Turning now descriptively to the drawings, in which similar reference characters denote similar elements throughout the several views, the Figures illustrate an absorbent, multi-layer article of the present invention. One of the advantages of the present invention is the relatively low cost of the article of the present invention that permits the article to be disposable if desired. Disposability is an important advantage in many applications particularly in the medical field where the spread of infection and other contagions is to be limited. Accordingly, the structures of the present invention will be described herein in relationship to their use in primarily as disposable absorbent articles. For the purpose of the present invention, a disposable absorbent article is an article which absorbs and contains liquids, such as body fluids and other liquids and prevents the fluids from spreading off of the sheet. Further, the term disposable is also intended to encompass sheets that will be discarded after a limited period of use. The articles are not typically intended to be laundered or otherwise restored for reuse. While the present description will generally be made in the context of a disposable absorbent article particularly a disposable sheet for medical use, it should be understood that the various structures of the present invention are also applicable to other articles such as incontinence pads, lab spill wipes and counter top pads, industrial spill sheets, operating room drapes, ambulance stretcher sheets, bed and crib pads absorbent wipes and the like. It is also contemplated that the present invention have applicability as a drape over operating table in the operating room, in a sterile operating room pack, as well as a fenestrated drape, i.e., a sheet that is placed over a patient or that portion of a patient that is being operated on. The sheet has an opening through the sheet that permits operating room personnel to work through the opening in the sheet. The opening may be merely one or more slits in the sheet that may be spread apart to give the operating room personnel an area in which to work. Alternatively, the opening may be an enlarged opening for example, in the form of a square or circle or other shape that accomplishes the same purpose. The absorbent material may be places on either side of the sheet or both sides as desired by the nature of the operation.

In dental offices, the sheet of the present invention may be used as a bib during dental procedures where the highly absorbent layer will permit the water, saliva and other fluids typically present to be absorbed. The sheet may also be a sheet or cover for the back board used to carry the patient. If made large enough the sheet can be wrapped about the patient and the sheet may be held in place by a suitable means such as a pin or by one or more Velcro fasteners. By weighing the sheet prior to use and comparing the weight of the sheet after use, medical personnel are given some idea as to the amount of blood lost be the patient.

Outside of the medical field, the present invention also has applicability in the area of pet care particularly in the veterinary field. The sheet may be used as a stretcher for animals. For another example, when used as a cover for the operating table in a veterinary hospital, the sheet of the present invention may be used because of its strength to pick up the operated on animal and carry the animal to the recovery area.

The subject matter of the present invention also has applicability in the area of highly absorbent undergarments as well. These undergarments may be used for children as well as adults who have problems with incontinence and can be in the form of a diaper or a preformed undergarment such as shorts.

Another example of the applicability of the present invention is in the area of a protector for bedding table covers and the like. This bedding can be a hospital bed, for home care, an incubator or Stablete, etc. The sheet of the present invention may be part of a pouch. The sheet on the present invention may be formed into a pouch having one sheet of the present invention on one surface and another sheet of the same or a different material on the other surface. The absorbent side of the sheet is preferably on the outer surface of at least one side of the pouch. The pouch typically has a generally rectangular shape although other shapes are possible. Other shapes would include circles, squares and combinations thereof. When generally rectangular, three of the sides of the pouch may be sealed by any suitable means and the fourth side remains open to permit a mattress or other object to be inserted therein. Depending on the application, the absorbent surface may be either on one or more of the inside surfaces of the pouch or on one or more outer surfaces of the pouch or combinations thereof. In another embodiment, the pouch of the present invention may have a top surface, a bottom surface, a first sidewall, a second sidewall and an end wall with the remaining end wall being open for insertion of an object. Alternatively, the pouch may have only a single side wall and a pair of end walls. The present invention may also be used as the interior surface of a container so that any fluids in the container or that leak in the container may be absorbed by the present invention. In another application of the invention, the sheet may be a mattress cover that is placed over a mattress to prevent damage to the mattress when fluids leak. In another embodiment, the sheet may be in the form of a traditional mattress cover with sides that are fitted to the mattress. Either the entire mattress cover can be made of the material of the present invention or only a portion of the area of the cover may be made of the sheet material of the present invention.

The material of the present invention may also be made into a glove. When made into a glove, either the entire glove may be made of the material of the present invention. Alternatively, either the palm surface or the opposite side of the glove may have the material of the present invention.

In most operating rooms throughout the country, the operating room personnel wear booties to protect their feet and also to prevent bacteria and other infectious agents from spreading in the room. During an operation, it is not uncommon for fluids to contact the booties. Most of the currently used booties slough off the fluids onto the floor where the fluids can be a hazard. The booties can be made of the material of the present invention where the absorbent layer is on the outer surface, the inner surface of both. With booties made from the material of the present invention, any fluids that come into contact with the outer surface of the booties are absorbed. This reduces the risk of a fall in the operating room.

In some forms of knee surgery, the knee is operated on by the surgeon with the leg in a non horizontal position, in these operations, it is very common for fluids to drip down the leg. A sleeve of the material of the present invention may be used to absorb the fluids that drip down the leg. The sleeve preferably has the absorbent material of the present invention on the interior surface of the sleeve although the absorbent surface can be on the inside surface or both surfaces as well. The sleeve may be either a tube open at each end so the leg can pass through or a sheet that releasably sealable along an edge and can be wrapped about the leg.

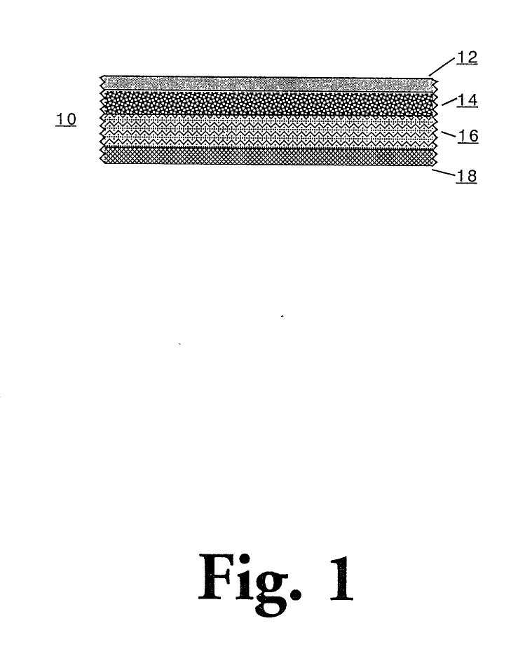

With reference to FIG. 1, an article of the present invention preferably includes at least four separate layers. The layers may be laminated together by any suitable means including the use of an adhesive to form a unitary structure 10. The layers do not have to be adhered together across their entire surface. In some instances, they may be sealed together about their perimeter edges and the remainder of the surface is not adhered to the adjacent layer. Alternatively, layers may be adhered together at other locations on their surface such as for example a series or plurality of connecting points in a variety of patterns across the surface of the layers. The four preferred layers are a topsheet layer 12, an absorbent layer 14, a fabric layer 16 and a backsheet layer 18. It will be appreciated that the surface layer 12 can be made of an absorbent material and the fabric layer may be eliminated so that the structure need only have one additional layer, the backsheet layer 18.

The topsheet layer 12 is made from a sheet of liquid permeable or semi-permeable material so that the liquid will pass through to the absorbent core which underlies the topsheet. The topsheet maybe composed of a substantially hydrophobic and substantially nonwettable material, and the hydrophobic material may optionally be treated with a surfactant or otherwise processed to impart a desired level of wettability and hydrophilicity. A suitable topsheet may be manufactured from a wide selection of web material, such as porous foams, reticulated foams, apertured plastic films, natural fibers (for example, wood or cotton fibers), synthetic fibers (for example, polyester or polypropylene fibers), or a combination of natural and synthetic fibers. Various woven and nonwoven fabrics can be used for the topsheet. For example, the topsheet may be composed or a meltblown or spunbonded web of polyolefin fibers. The topsheet may also be a bonded-carded-web composed of natural and/or synthetic fibers, such as, for example, the preferred nonwoven polypropylene, polyester, polyethylene or poly/acrylic blend fabric. With regard to the weight of the topsheet, it is preferred that it have a basis weight between about 10 and 40 grams per square meter (g/m²)

For medical applications, the topsheet should be made of a hypoallergenic material can be sterilized. Furthermore, in applications where the article is in contact with a person's skin, it is preferred that the topsheet remain dry to the touch after allowing the liquid to pass through to the absorbent core. This is readily accomplished by the aforementioned use of hydrophobic material and surface treatments. The use of absorbent materials that convert the liquid to a gel form further assists this goal. In a preferred embodiment, the material of the topsheet is selected not only for its wettability and hydrophilicity but also for its softness to any skin that comes into contact therewith.

The backsheet 18 is composed of a material which is configured to be substantially impermeable to liquids. For example, a typical backsheet can be manufactured from a thin plastic film, or other flexible liquid-impermeable material. The backsheet typically helps to prevent the absorbed liquids contained in the absorbent layer from wetting articles or people in contact with the article. For example, the backsheet acts to protect bed linens, counter tops, lab benches floors and the like. Also, when used in the form of disposable cleaning pads/wipes, the backsheet acts to prevent contact of the user with the substance being cleaned. This is particularly crucial when infectious or toxic wastes are concerned. In such instances, the backsheet actually becomes an isolating wrap for disposal of the used article, allowing the user to touch the impervious backing layer and not the contaminated surface. When use for example in a medical setting either in a hospital doctors office or on an EMS board, the amount of blood or other fluid that the patient has lost can be roughly calculated by weighing the sheets after use and comparing the weight to the weight of an unused pad. In applications where sterility is needed the sheets of the present invention may be sterilized by gamma rays or a sterilizing gas.

In particular embodiments, the backsheet 18 is a polypropylene, polyethylene or polyester film having a thickness of from about 0.012 millimeters (0.5 mil) to about 0.051 millimeters (2.0 mils), preferably about 0.025 millimeters (1.0 mil). The backsheet may be made from such polyethylenes as linear low density polyethylene, very low density polyethylene, ultra low density polyethylene. The backsheet 18 typically provides the outer cover of the article. Optionally, however, the article may have the fabric layer 16 as the outermost layer in the article.

The absorbent layer 14 is typically positioned between the topsheet 12 and the fabric layer 16. Optionally, however, it can be disposed between the topsheet 12 and the backsheet 18, when the fabric layer 16 is the outermost layer as discussed above. Various types of wettable, hydrophilic fibrous material can be used to form the absorbent layer. Examples of suitable fibers include naturally occurring organic fibers composed of intrinsically wettable material such as cellulosic fibers, synthetic fibers composed of cellulose or cellulose derivatives, such as rayon fibers; inorganic fibers composed of an inherently wettable material, such as glass fibers; synthetic fibers made from wettable thermoplastic polymers, such as particular polyester or polyamide fibers; and synthetic fibers composed of a nonwettable thermoplastic polymer, such as polypropylene fibers, which have been hydrophilized by appropriate means. The fibers may be hydrophilized for example, by treatment with silica, treatment with a material which has a suitable hydrophilic moiety and is not readily removable from the fiber, or by sheathing the nonwettable, hydrophobic fiber with a hydrophilic polymer during or after the formation of the fiber. It is also contemplated that selected blends of the various types of fibers mentioned above may also be employed. Preferably, the absorbent core is made of a material which converts liquids to gel foam, as is well known in the art. The absorbent layer may also be provided with a deodorant material in the layer.

The absorbent layer 14 preferably has a basis weight between about 100 and 400 g/m², most preferably about 300 g/m² This will generally correspond to a thickness of between about 1 and 6 mm usually between about 3 and 5 mm. With regard to absorbency, it can readily be appreciated that the ability of the article to absorb liquid depends substantially on the nature of the liquid being absorbed. Speaking generally, however, the absorbent layer should have an absorbent capacity of at least about 15 grams of saline solution g/g during one minute and/or at least up 20 grams of water per gram of sorbent (g/g) during one minute, preferably at least 20 grams of saline solution g/g and/or at least 25 g/g water. More preferably, the absorbent layer should have an absorbent capacity of at least about 25 grams of saline solution g/g during one minute and/or at least up 30 grams of water per gram of sorbent (g/g) during one minute. Most preferably, the absorbent layer should have an absorbent capacity of at least about 30 grams of saline solution g/g during one minute and/or at least up 35 grams of water per gram of sorbent (g/g) during one minute. One material that can be used contains cellulosic fibers, e.g., wood pulp fluff made up of bleached sulphate wood pulp containing softwood fibers, such as that available from International Paper, Tuxedo, N.Y., co-mingled with hydrogel polymer particulates (known as Super Absorbent Polymer or “SAP”) A preferred material for providing suitable absorption in the absorbent layer is material in the form of a powder or granules sold by Stockhausen. These granules are made up of a Super Absorbent Polymer such as Stockhausen Favor SXM 70 polymer and can be interspersed throughout the material that makes up the absorbent layer.

In a preferred embodiment, the absorbent layer may have the following structure:

45-65% Long Staple Hardwood Fiber Pulp

15-25% Binding Fiber

20-30% Super Absorbent Polymer

### EXAMPLE 1

The absorbent layer is preferably:

57% Long Staple Hardwood Fiber Pulp

19% Binding Fiber

24% Super Absorbent Polymer

Alternatively, the absorbent layer may be

45-65% Long Staple Hardwood Fiber Pulp

15-25% Binding Fiber

20-30% Super Absorbent Fiber

### EXAMPLE 2

57% Long Staple Hardwood Fiber Pulp

18% Binding Fiber

25% Super Absorbent Polymer

The fabric layer 16 provides the article 10 with its high tensile strength. This layer as described earlier can be disposed either between the absorbent layer 14 and the backsheet layer 18 or, optionally, could form the outer layer, that is the backsheet layer 18 is disposed between the absorbent layer 14 and the fabric layer 16. This layer is composed of a flexible sheet with a high tensile strength. When the fabric layer is disposed adjacent to the absorbent layer, it is important that it retain its tensile strength when wet. The fabric layer 16 should have a tensile strength sufficient to provide the article with a tensile strength high enough to enable the article to lift, for example, a pet or other animal when used in veterinary applications or an adult person when used in many medical applications. The composite sheets of the present invention may be used to carry a patient or a pet weighing 100 pounds or more without tearing even when wet due to the presence of fluids that have been absorbed into the sheet. If desired, the sheets may be provided with hand holds to assist the medical personnel in moving a patient.

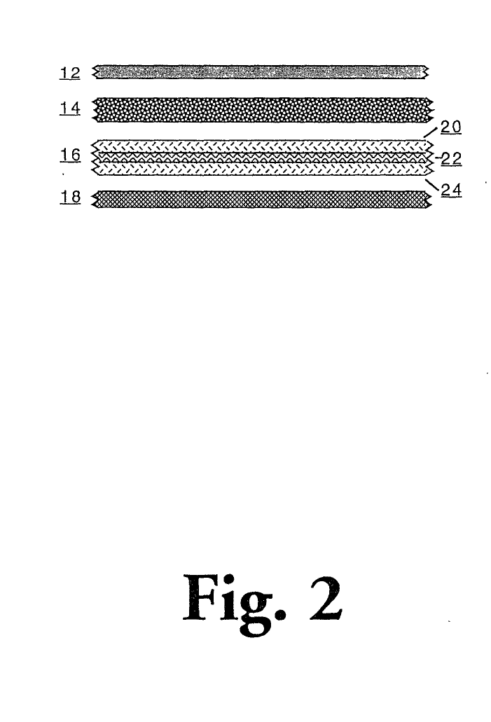

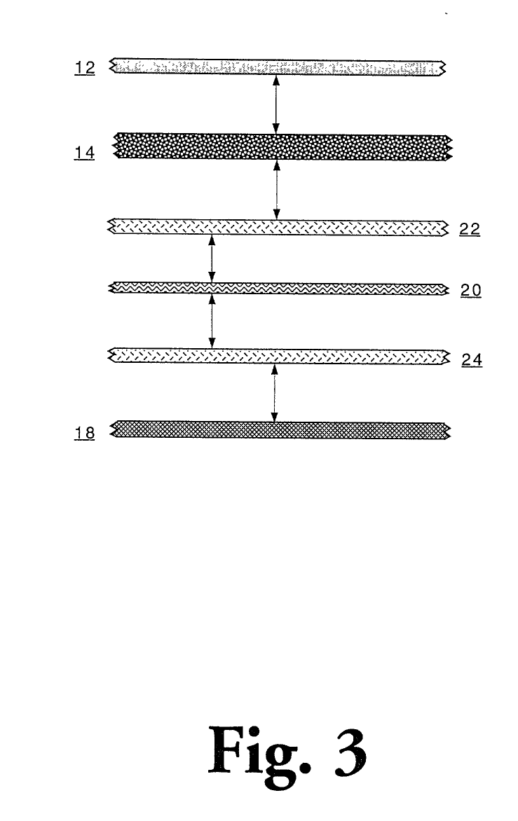

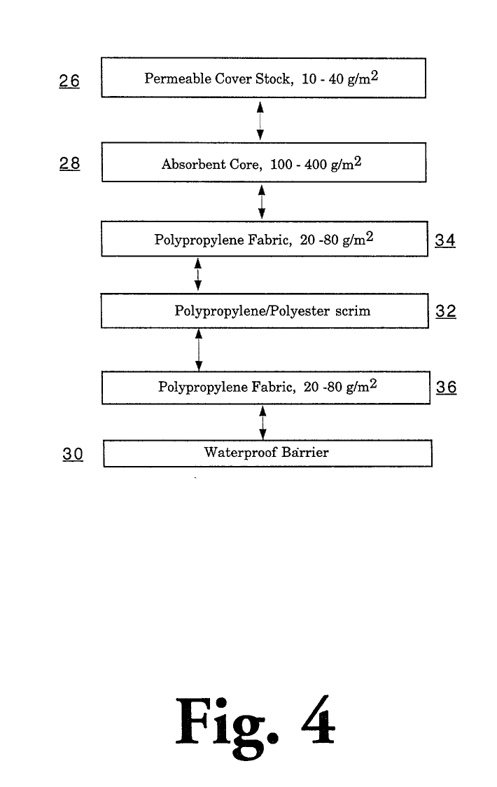

With reference to FIGS. 2 and 3, it can be seen that the fabric layer 16 itself can be composed of a plurality of separate layers laminated together. For example, as illustrated in the Figures, the fabric layer 16 can be made up of two fabric layers 20 and 24. These layers can be laminated together or if desired they may be laminated to opposite sides of a support layer 22. Such a structure provides the article with an even greater tensile strength, especially if each of the fabric layers has a tensile strength higher along one longitudinal axis than the other in which case the two fabric layers are oriented in opposite longitudinal directions.

The fabric layer(s) can be made of any of a wide variety of materials, as long as adequate tensile strength is provided. Preferred materials include, for example a polymeric fabric including but not limited to a polyethylene, a polypropylene polyester or other fabric having a basis weight between about 20 and 80 g/m². With regard to the support layer 22, a flexible polypropylene or polyester scrim is preferred. The scrim is preferably in the form of a mesh or net to reduce cost while at the same time providing superior tensile strength. The precise nature of the support layer is not critical however, as long as it provides an appropriate surface for laminating the two fabric layers thereto.

In one embodiment, the fabric layer 16 and the backsheet layer 18 may be laminated together by any suitable means such as an adhesive, a solvent weld or by co-extruding the layers. The remaining layers may be added subsequently to this base structure. Alternatively, the topsheet 12 and absorbent layer may be laminated together and the fabric layer or a composite of the fabric layer and the backsheet layer may be joined this substrate. Similarly, where the fabric layer has two fabric layers that are adjacent to each other or two fabric layers on either side of a support layer, these layers can be laminated together by any suitable means such as an adhesive, a solvent weld or by coextruding the layers. To the so formed substrate may be added the remaining layers by any suitable means.

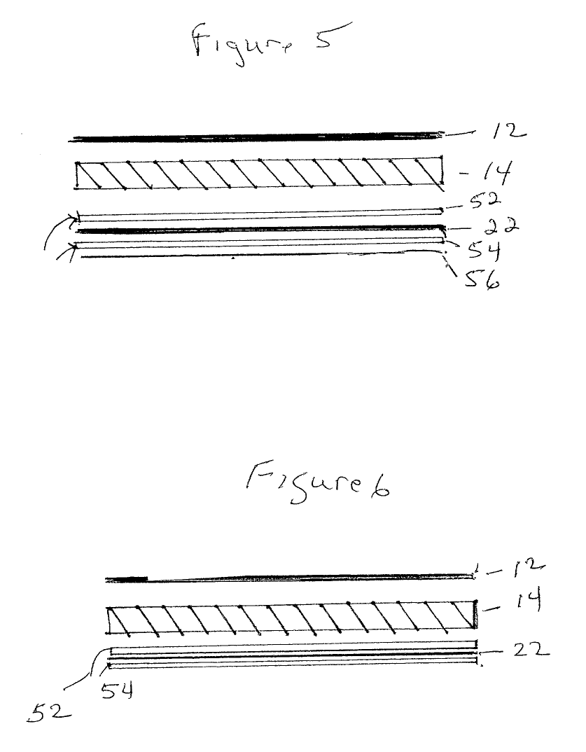

FIGS. 5 and 6 show alternative embodiments of the present invention. In FIG. 5 there is a cover stock layer or top sheet 12 as the outer layer. Below and preferably adjacent to the top sheet is a layer of superabsorbent material 14 which may be a superabsorbent polymer containing layer, fiber or the other materials discussed above. The next layer is preferably a three layer composite of a scrim core layer 22 with a polymeric material 52 and 54 on either side. The polymeric material on either side preferably has a basis weight of between about 2 and about 10 g/m² The scrim core layer 22 provides strength to the overall structure and is preferably a 12 by 4 mesh of a polymeric material. If the polymeric material 54 is a barrier material, no additional layers are necessarily present. If the polymeric material 54 is not a barrier material, it is preferred that there be an additional barrier layer 56 present.

In FIG. 6 there is no barrier layer and the three layer composite having a scrim core layer has a material that allows fluids to pass through the layer 54, the scrim 22 and the layer 52. This structure allows absorbency from both sides of the structure.

It will be appreciated by those skilled in the art that the present invention can be manufactured in a number of different ways. One preferred manner of manufacturing is be means of a process that employs a first heating area that brings the temperature of the materials to be fused to a first temperature of at least 50°. From the first heating area the materials to be fused enters a preheat zone where the fusing material that is heated to a fluidity temperature. From the preheat zone the material enters in succession a plurality of areas where heat is applied to one side of the material and then to the other side of the material so that the fusible resin is drawn toward the heat that is being applied. This permits the resin to penetrate the material to be assembled. Once the appropriate temperature is reached in the plurality of heating zones the material is fused together by at least one pair of rollers. After rolling the fused material is kept under slight pressure to retain the material together and permitted to gradually cool down without the application of additional heat. From this light pressure area, the material passes to a cooling area where the material is permitted to cool down without pressure on the material.

It will be understood that each of the elements described above, or two or more together, may also find a useful application in other types of applications differing from the type described above.

While the invention has been illustrated and described as embodied in a disposable absorbent article, it is not intended to be limited to the details shown, since it will be understood that various omissions, modifications, substitutions and changes in the forms and details of the formulation illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that from the standpoint of prior art fairly, constitute essential characteristics of this invention.

What is claimed as new and desired to be protected by Letters Patent is set forth in the appended claims.

1. A disposable, absorbent article, comprising:
a) a liquid impervious backsheet layer;
b) a liquid permeable topsheet layer which is disposed in facing relation with said backsheet layer;
c) an absorbent layer which is interposed between said backsheet layer and said topsheet layer; and
d) a first fabric layer which is interposed between said backsheet layer and said absorbent layer.

2. An article as defined in claim 1 further comprising a second fabric layer which is disposed in facing relation with said first fabric layer.

3. An article as defined in claim 1 wherein the first fabric layer is comprised of a scrim material.

4. The article according to claim 2 wherein the firsts and second fabric layers are comprised of a scrim material.

5. The article according to claim 4 further comprising: a scrim support layer which is interposed between and laminated to said first and second fabric layer.

6. An article as defined in claim 1 wherein said first fabric layer is polypropylene fabric.

7. An article as defined in claim 6 wherein said polypropylene fabric has a basis weight of between about 20 and about 80 g/m².

8. An article as defined in claim 2 wherein said first and second fabric layers are polypropylene fabric.

9. An article as defined in claim 9 wherein said polypropylene fabric has a basis weight of between about 20 and about 80 g/m².

10. An article as defined in claim 5 wherein said scrim support layer is selected from the group consisting of polypropylene and polyester.

11. An article as defined in claim 10 wherein said liquid-permeable topsheet layer, is selected from the group consisting of polyacrylic, polypropylene, polyolefin and polyester having a basis weight of between about 0 and about 40 g/m².

12. An article as defined in claim 1 wherein said absorbent core has a basis weight of between about 100 and about 400 g/m².

13. A disposable absorbent article, comprising;
a) a fabric backsheet layer;
b) a liquid permeable topsheet layer which is disposed in facing relationship with said fabric backsheet layer;
c) an absorbent layer which is interposed between said fabric backsheet layer and said topsheet layer; and
d) a liquid-impervious layer which is interposed between said fabric backsheet layer and said absorbent layer.

14. An article defined in claim 13 further comprising a second fabric layer which is disposed in facing relation with said first fabric layer.

15. An article as defined in claim 13 wherein the first fabric layer is comprised of a scrim material.

16. The article according to claim 14 wherein the firsts and second fabric layers are comprised of a scrim material.

17. An article as defined in claim 16 further comprising a scrim support layer which is interposed between and laminated to said first and second fabric layers.

18. An article as defined in claim 13 wherein said first fabric layer is polypropylene fabric.

19. An article as defined in claim 18 wherein said polypropylene fabric has a basis weight of between about 20 and about 80 g/m².

20. An article as defined in claim 14 wherein said first and second fabric layers are polypropylene fabric.

21. An article as defined in claim 20 wherein sale polypropylene fabric has a basis weight of between about 20 and about 80 g/m².

22. An article as defined in claim 21 wherein said scrim support layer is selected from polypropylene and polyester.

23. An article as defined in claim 22 wherein said liquid-permeable topsheet layer is selected from polyacrylic, polypropylene polyolefin and polyester having a basis weight of between about 10 and about 40 g/m².

24. An article as defined in claim 13 wherein said absorbent core has a basis weight of between about 100 and about 400 g/m².

25. A disposable, absorbent article, comprising:
a) a liquid impervious backsheet layer;
b) an absorbent layer on said backsheet layer.

26. The article according to claim 25 wherein there is a liquid permeable topsheet layer which is disposed in facing relation with said backsheet layer over said absorbent layer.

27. The article according to claim 25 wherein there is a first fabric layer which is interposed between said backsheet layer and said absorbent layer.

28. An article according to claim 2 wherein the first fabric layer has a greater tensile strength in one direction and the second fabric layer has a greater tensile strength in a direction at a right angle to the direction of strength of the first fabric layer.

29. An article according to claim 14 wherein the first fabric layer has a greater tensile strength in one direction and the second fabric layer has a greater tensile strength in a direction at a right angle to the direction of strength of the first fabric layer.

30. The article according to claim 25 further comprising an absorbent layer on each side of said backsheet layer.

31. The article according to claim 30 wherein there is a liquid permeable topsheet layer which is disposed in facing relation with said backsheet layer over each of said absorbent layers.

32. The article according to claim 30 wherein there is a first fabric layer which is interposed between said backsheet layer and one of said absorbent layers.

33. The article according to claim 26 formed into a pouch.

34. The article according to claim 26 formed into a bootie.

35. The article according to claim 26 formed into a fenestrated drape.

36. The article according to claim 26 formed into a glove.

37. The article according to claim 26 formed into a bib.
